(19) United States
(12) Patent Application Publication
(10) Pub. No.: US 2018/0224937 A1
(43) Pub. Date: Aug. 9, 2018

(54) INPUT AND OUTPUT DEVICE WITH TACTILE FEEDBACK

(71) Applicant: FORD GLOBAL TECHNOLOGIES, LLC, Dearborn, MI (US)

(72) Inventor: Matthew Anthony Majkowski, Dearborn, MI (US)

(21) Appl. No.: 15/428,267

(22) Filed: Feb. 9, 2017

(51) Int. Cl. G06F 3/01; H04R 7/04

(52) U.S. Cl. CPC G06F 3/016; H04R 7/04; G06F 3/041; H04R 2499/13; H04R 2499/15; H04R 2400/03

(57) ABSTRACT

An input and output device includes a speaker diaphragm and a touch sensor carried on the speaker diaphragm. The input and output device may also include a display device oriented to display an image through the speaker diaphragm and the touch sensor. Further, the input and output device includes a control module configured to provide integrated operation of the speaker diaphragm, the touch sensor and the display device as well as tactile and audio feedback through the speaker diaphragm when the touch sensor senses a touch.

### TECHNICAL FIELD

This document relates generally to the motor vehicle equipment field and, more particularly, to an input and output device that provides audio, visual and tactile information and feedback through a speaker diaphragm.

### BACKGROUND

There is a limited amount of packaging space for all motor vehicle applications. Additional component counts lead to additional cost and complexity. This is particularly true in the center stack of the motor vehicle where multiple modules are required to share limited space. Significantly, the limited available space also limits total styling options as only so much surface area is available.

FIG. 1a illustrates current state of the art technology. FIG. 1a illustrates a center stack C, an independent display screen D for displaying of images I, independent speakers S for providing audio output and independent buttons B to allow for device inputs by the motor vehicle operator or other individuals in the motor vehicle. As should be appreciated from viewing FIG. 1a, the independent display screen D, speakers S and buttons B consume a substantial portion of the surface area of the center stack C effectively limiting the size of the display screen and the manner in which the independent components may be laid out on the surface of the center stack.

This document relates to a new and improved input and output device that provides for integrated audio and visual outputs, operator inputs and tactile feedback to operator inputs in a single assembly. By eliminating the need for independent speakers S and independent input buttons B, the new and improved input and output device reduces clutter on the center stack C and conserves surface area. Accordingly, the new and improved input and output device may be made larger if desired as greater space is conserved on the center stack C to accommodate the display screen. This enhances display screen visibility for easy and more efficient viewing by a driver or other occupant of the motor vehicle.

In addition, the new and improved input and output device is integrated in a manner requiring fewer parts and less complexity to assemble and mount in the motor vehicle. Touch inputs may also be provided with both audio and haptic or tactile feedback that immediately confirms user inputs thereby enhancing customer operating confidence and satisfaction. In addition, the compact integrated input and output device enhances options for packaging and styling of the interior of the motor vehicle including, particularly, the center stack.

### SUMMARY

In accordance with the purposes and benefits described herein, a new and improved input and output device is provided. That input and output device comprises a speaker diaphragm and a touch sensor carried on the speaker diaphragm.

The input and output device also includes an actuator driving the speaker diaphragm. The speaker diaphragm may be made from a first optically clear or transparent material and the touch sensor may be made from a second optically clear or transparent material. The first and second materials may be like materials or different materials.

The input and output device may also include a display device oriented to display an image through the speaker diaphragm and the touch sensor. The touch sensor may be printed as a touch sensor layer on the speaker diaphragm and packaged between the speaker diaphragm and the display device.

The input and output device may also include a control module. That control module may be configured to provide both tactile and audio feedback through the speaker diaphragm when the touch sensor senses a touch. Further, it should be appreciated that the control module may be configured to provide integrated operation of the speaker diaphragm, the touch sensor and the display device.

In accordance with yet another aspect, a floating control and speaker apparatus is provided. That floating control and speaker apparatus comprises a speaker diaphragm and a touch sensor layer printed on the speaker diaphragm. The floating control and speaker apparatus may further include a visual display, such as at least one LED printed on the speaker diaphragm. Still further, the floating control and speaker apparatus may further include a rylene dye layer printed on the speaker diaphragm. In addition, the floating control speaker apparatus may further include an actuator for driving the speaker diaphragm so as to generate desired sound. Further, the floating control and speaker apparatus may include a support base engaging the speaker diaphragm only along one side. In such an embodiment, three sides of the speaker diaphragm are free floating. This allows the floating control and speaker apparatus to be mounted at the top of the center stack and if desired even projecting between the dashboard and the windshield of a motor vehicle.

In accordance with still another aspect, a method is provided for incorporating integrated audio and haptic feedback into an input and output device. That method may be described as comprising the steps of: (a) overlying a touch sensor with a speaker diaphragm, (b) detecting, by said touch sensor, a touch on the speaker diaphragm over the touch sensor, and (c) vibrating, by actuator, the speaker diaphragm in response to the touch.

The method may also include the step of packaging a display device behind the speaker diaphragm and the touch sensor. Further, the method may include displaying an image on the display device through the touch sensor and the speaker diaphragm. Toward this end it should be appreciated that the method may include the step of using optically clear materials for the speaker diaphragm and the touch sensor layer.

In addition, the method may include the step of providing audio, visual and tactile information and feedback through the speaker diaphragm. Further, the method may include printing the touch sensor as a touch sensor layer on the face of the speaker diaphragm. In addition, the method may include the step of configuring a control module to provide integrated operation of the speaker diaphragm, the touch sensor layer and the display device.

In the following description, there are shown and described several preferred embodiments of the input and output device, the floating control and speaker apparatus and the method of providing an input and output device with integrated audio and haptic feedback. As it should be realized, the input and output device, the floating control and speaker apparatus and the related method are capable of other, different embodiments and their several details are capable of modification in various, obvious aspects all without departing from the input and output device, the floating control and speaker apparatus and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the input and output device, the floating control and speaker apparatus and the method and together with the description serve to explain certain principles thereof. :

FIG. 1 is a schematic illustration of a center stack of a motor vehicle incorporating prior art technology including independent speakers, display screen and input buttons.

FIG. 2 is a view similar to FIG. 1 but illustrating the same center stack equipped with a new and improved input and output device which provides audio, visual and tactile information and feedback through a single speaker diaphragm.

FIG. 3 is a schematic side elevational representation of the new and improved input and output device illustrated in FIG. 2.

FIG. 4 is a schematic block diagram of a control module for the integrated operation of the input and output device illustrated in FIGS. 2 and 3.

FIGS. 5a-5c are respective front elevational, side elevational and schematical views of the floating control and speaker apparatus.

Reference will now be made in detail to the present preferred embodiments of the input and output device and the floating control and speaker apparatus, examples of which are illustrated in the accompanying drawing figures.

### DETAILED DESCRIPTION

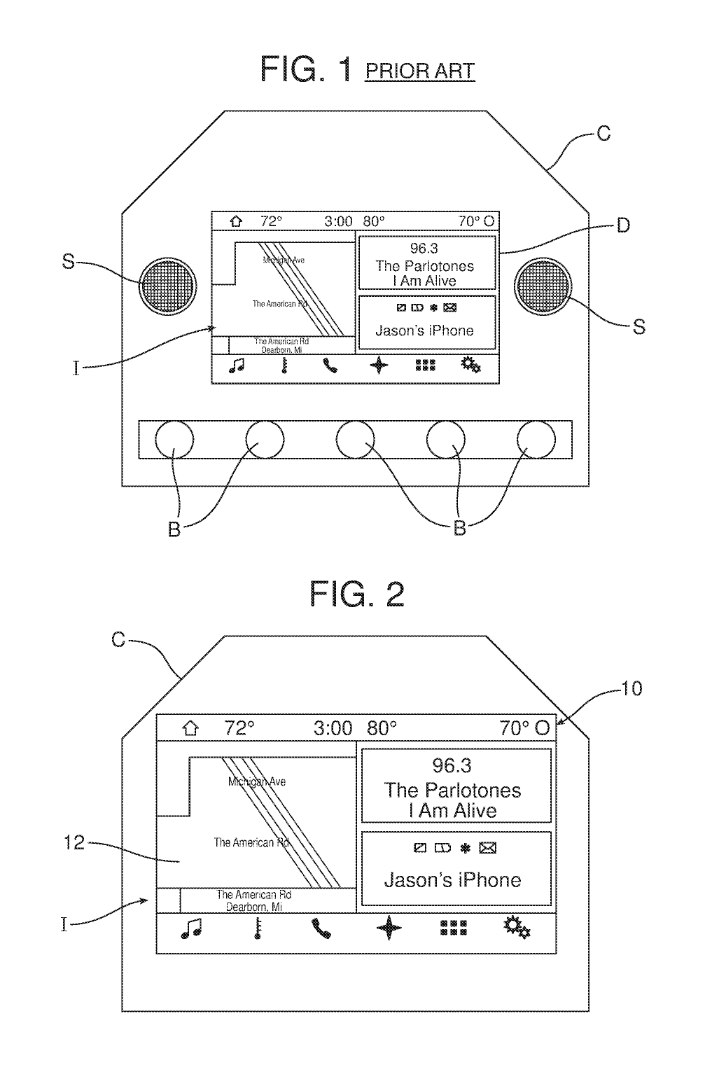

Reference is now made to FIG. 2 illustrating the new and improved input and output device 10 in a center stack C of a motor vehicle. The input and output device 10 is configured to provide audio, visual and tactile information and feedback through a speaker diaphragm 12 of the input and output device. Thus, as should be appreciated from comparing FIGS. 1 and 2, the new and improved input and output device 10 eliminates the need to house separate speakers S and separate input buttons B on the center stack C thereby freeing surface area up for styling and design purposes or for a larger image display screen as will be described in greater detail below.

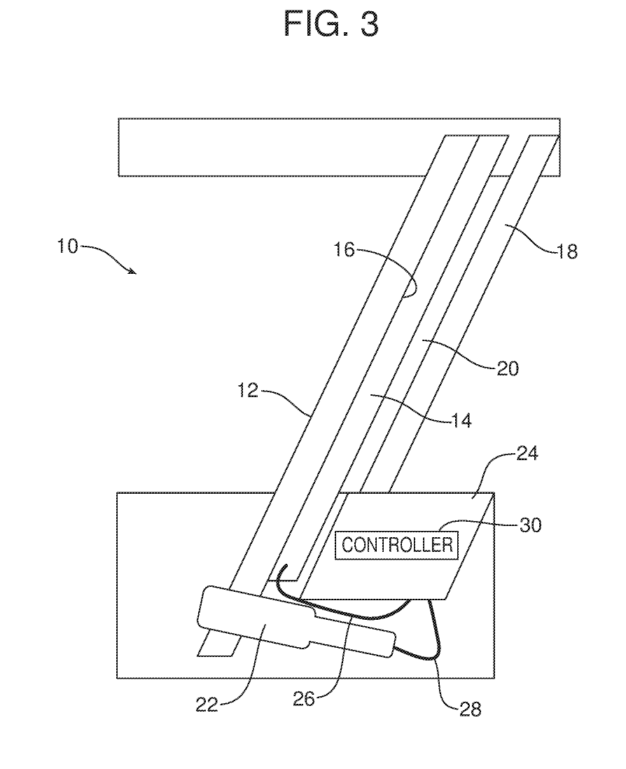

As schematically illustrated in FIG. 3, the input and output device 10 includes the speaker diaphragm 12 and a touch sensor 14. In the illustrated embodiment, the touch sensor 14 comprises a touch sensor layer that may be bonded to the face 16 of the speaker diaphragm 12 using a transparent adhesive of a type known in the art. A display device 18 may be provided behind the speaker diaphragm 12 and oriented to display an image I (see also FIG. 2) through the speaker diaphragm and the touch sensor 14. The display device 18 may be of a type known in the art such as a liquid crystal display.

In order to accommodate the display of an image through the speaker diaphragm 12 and the touch sensor layer 14, both the speaker diaphragm 12 and the touch sensor layer 14 are made from optically clear or transparent material.

In one possible embodiment, the speaker diaphragm 12 is made from a sheet of optically clear acrylic material or glass and the touch sensor 14 is made from an optically clear layer of conductive traces of a type also known in the art and used in current touch screen technology. Generally, it should be appreciated that the speaker diaphragm 12 may be made from a first optically clear material while the touch sensor 14 may be made from a second optically clear material. The first optically clear material and the second optically clear material may be like or different. As further appreciated from viewing FIG. 3, the touch sensor layer 14 printed on the speaker diaphragm 12 may be packaged between the speaker diaphragm and the display device 18. An air gap 20 is provided between the speaker diaphragm 12 and printed touch sensor 14 on one side and the display device 18 on the other in order to accommodate motion of the speaker diaphragm.

An actuator 22 is provided to drive the speaker diaphragm 12 to produce desired sounds. The actuator 22 may be a piezoelectric actuator adapted to stimulate the speaker diaphragm 12 in order to produce the necessary vibration and motions for the generation of the desired sound.

As further illustrated in FIG. 3, the input and output device 10 further includes a control module 24. Control module 24 is configured to provide both tactile and audio feedback through the speaker diaphragm 12 when the touch sensor 14 senses a touch through the speaker diaphragm by a device operator. Toward this end, the control module 24 includes a first lead 26 connected to the touch sensor 14 and a second lead 28 connected to the actuator 22.

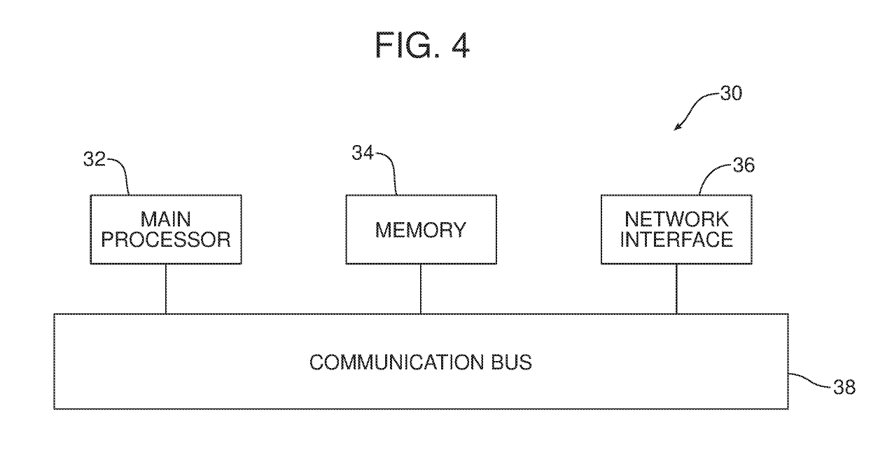

The control module 24 includes a controller 30 in the form of a computing device such as a dedicated microprocessor or an electronic control unit operating in accordance with instructions from appropriate control software. Thus, as illustrated in FIG. 4, the controller 30 may include one or more processors 32, one or more memories 34 and one or more network interfaces 36 all communicating with each other over a communication bus 38.

The controller 30 may interface with the body control module (not shown) of the motor vehicle through a communication area network or CAN.

As should be apparent from this description, the control module 24, including the controller 30, is configured to provide integrated operation of the speaker diaphragm 12, the touch sensor 14 and the display device 18.

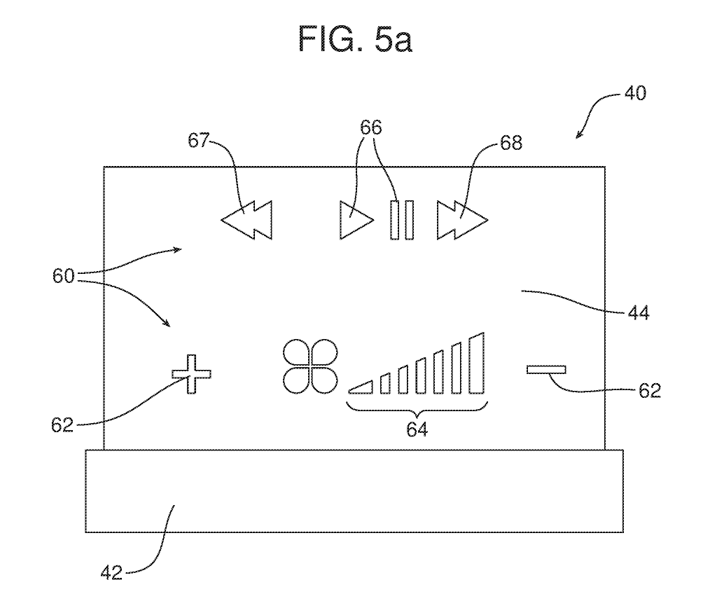

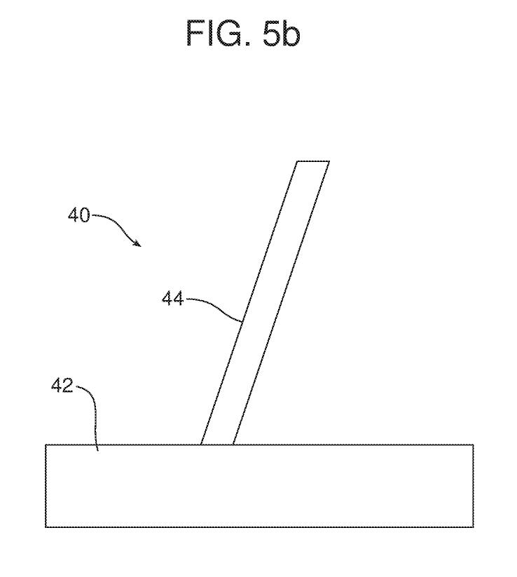

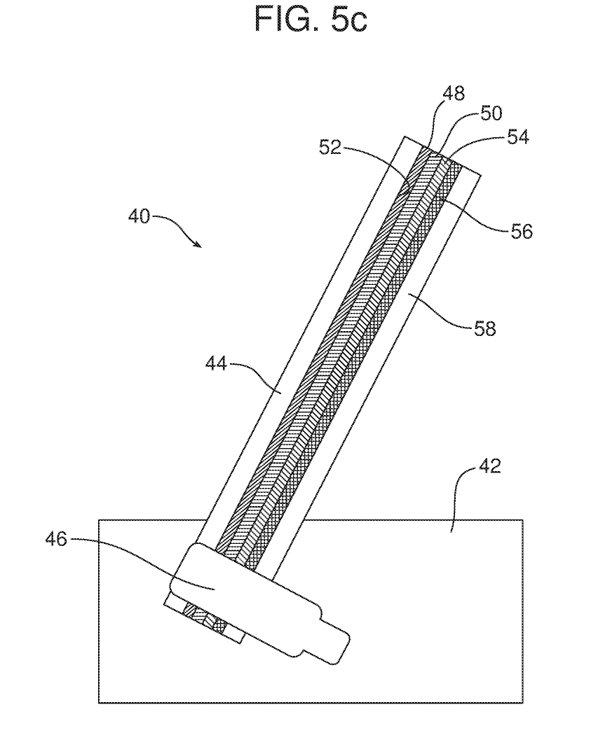

Reference is now made to FIGS. 5a-5c illustrating a floating control and speaker apparatus or device 40. As best illustrated in FIG. 5c the floating control speaker apparatus 40 includes a base 42 which holds an optically clear speaker diaphragm 44 which is driven by an actuator 46 to generate desired sound. An opaque masking paint 48 may be provided around the perimeter of the speaker diaphragm 44. A transparent touch sensor layer 50 is bound to the inner face of the speaker diaphragm 44 inside the opaque perimeter paint 48 utilizing a clear adhesive of a type known in the art.

The speaker diaphragm 44 may also be printed with a visual display of any desired nature such as motor vehicle system control icons. In the illustrated embodiment, a photoluminescent layer of rylene dye or the like 54 is provided behind the touch sensor layer 50 and in front of a printed LED layer 56. In use, the printed LED layer 56 is activated and emits light which excites the rylene dye layer 54 to light the display screen to illustrate the position of various controls on the speaker diaphragm 44 through the various symbols 60 (see FIG. 5a). In the illustrated embodiment, the “+” and “−” symbols 62 may be touched to raise or lower the temperature to be maintained by the HVAC system of the motor vehicle. One can also control the speed of the fan of the HVAC system by moving a finger over the speaker diaphragm 44 across the gradient symbol 64. Further, in the illustrated embodiment, one may control the operation of the CD player of the motor vehicle by touching the speaker diaphragm over the rewind, fast forward and play/pause symbols 66, 68, 70. As with the previously described embodiment of the input and output device 10, the floating control speaker apparatus 40 provides audio and tactile feedback when an individual operator touches the speaker diaphragm 44 over one of the symbols 60. That feedback may be in the form of a mild tactile vibration and audio buzz to provide the operator with immediate confirmation of his control inputs to the floating control speaker apparatus 40.

As should be appreciated from reviewing FIGS. 5a and 5b, the base 42 holds the speaker diaphragm 44 along one side leaving three sides exposed or free. This allows the floating control speaker apparatus 40 to be mounted, for example, at the top of the dashboard where it is easily viewed and accessed. As shown in FIG. 5c, the floating control speaker apparatus 40 may also include an optimal backing 58 to protect the layers 48, 50, 54, 56 from physical and electrical damage.

Consistent with the above description, a method of providing an input and output device 10 with integrated audio and haptic feedback is provided. That method may be described as comprising the steps of overlying a touch sensor 14 with a speaker diaphragm 12, detecting, by the touch sensor, a touch on the speaker diaphragm over the touch sensor and vibrating, by the actuator 22 the speaker diaphragm in response to the touch.

As best illustrated in FIG. 3, the method may include packaging a display device 18 behind the speaker diaphragm 12 and the touch sensor 14. Further, as best illustrated in FIGS. 2 and 3, the method may include displaying an image Ion the display device 18 through the touch sensor 14 and the speaker diaphragm 12 which forms the front or operator facing component of the input and output device 10.

As made clear in the above description, the input and output device effectively provides audio and visual output, touch input and tactile information and feedback through a single surface, the speaker diaphragm 12. Toward this end the control module 24 is configured to provide integrated operation of the speaker diaphragm 12, the touch sensor layer 14 and the display device 18 and single point operation through the speaker diaphragm 12.

The foregoing has been presented for purposes of illustration and description. It is not intended to be exhaustive or to limit the embodiments to the precise form disclosed. Obvious modifications and variations are possible in light of the above teachings. For example, the touch sensor or touch sensor layer 14 and 50 of the above described embodiments of the input and output device 10 and floating control speaker apparatus 40 are of the capacitive type. It should be appreciated that other types of touch sensor may be utilized in the input and output device 10 and floating control speaker apparatus 40 described herein. All such modifications and variations are within the scope of the appended claims when interpreted in accordance with the breadth to which they are fairly, legally and equitably entitled.

1. An input and output device, comprising:
a speaker diaphragm having a first edge and a second edge opposite said first edge;
a touch sensor carried on said speaker diaphragm; and
a base engaging said speaker diaphragm only along said first edge, said second edge being free of said support base.

2. The input and output device of claim 1, further including an actuator driving said speaker diaphragm.

3. The input and output device of claim 2, wherein said speaker diaphragm is made from a first optically clear material.

4. The input and output device of claim 3, wherein said touch sensor is made from a second optically clear material.

5. The input and output device of claim 4, further including a display device oriented to display an image through said speaker diaphragm and said touch sensor.

6. The input and output device of claim 5, wherein said touch sensor is printed as a touch sensor layer on said speaker diaphragm and packaged between said speaker diaphragm and said display device.

7. The input and output device of claim 6, further including a control module configured to provide both tactile and audio feedback through said speaker diaphragm when said touch sensor senses a touch.

8. The input and output device of claim 7, wherein said control module is configured to provide integrated operation of said speaker diaphragm, said touch sensor and said display device.

9. A floating control and speaker apparatus, comprising:
a speaker diaphragm;
a touch sensor layer printed on said speaker diaphragm; and
a base engaging said speaker diaphragm only along one side.

10. The floating control and speaker apparatus of claim 9, further including visual display printed on said speaker diaphragm.

11. The floating control and speaker apparatus of claim 10, further including at least one LED as the visual display and a rylene dye layer printed on said speaker diaphragm.

12. The floating control and speaker apparatus of claim 11, further including an actuator driving said speaker diaphragm.

13. (canceled)

14. A method of providing an input and output device with integrated audio and haptic feedback, comprising:
overlying a touch sensor with a speaker diaphragm;
detecting, by said touch sensor, a touch on said speaker diaphragm over said touch sensor;
vibrating, by actuator, said speaker diaphragm in response to said touch; and
engaging said speaker diaphragm with a base only along one edge of said speaker diaphragm.

15. The method of claim 14, including packaging a display device behind said speaker diaphragm and said touch sensor.

16. The method of claim 15, including displaying an image on said display device through said touch sensor and said speaker diaphragm.

17. The method of claim 16, including providing audio, visual and tactile information and feedback through said speaker diaphragm.

18. The method of claim 17, including printing said touch sensor as a touch sensor layer on a face of said speaker diaphragm.

19. The method of claim 18, including configuring a control module to provide integrated operation of said speaker diaphragm, said touch sensor layer and said display device.

20. The method of claim 19, including using optically clear materials for said speaker diaphragm and said touch sensor layer.
